(19) United States
(12) Patent Application Publication
(10) Pub. No.: US 2022/0332851 A1
(43) Pub. Date: Oct. 20, 2022

(54) METHOD FOR PRE-TREATING AND DYEING CELLULOSE

(71) Applicant: BENNINGER AG, Uzwil (CH)

(72) Inventor: Jürgen STRÖHLE, Dornbirn (AT)

(21) Appl. No.: 17/760,610

(22) PCT Filed: Sep. 8, 2020
(86) PCT No.: PCT/EP2020/075004

§ 371 Date: Mar. 15, 2022

(30) Foreign Application Priority Data
Sep. 16, 2019 (EP) 19197555.6

(51) Int. Cl. C08B 1/00; C11D 3/395; C11D 3/39; C11D 3/40

(52) U.S. Cl. CPC C08B 1/00; C11D 3/395; C11D 3/3937; C11D 3/40

(57) ABSTRACT

A method for pretreating and dyeing cellulose (2), comprising the steps of: providing a cellulose (2), carrying out a cationization reaction and carrying out a bleaching reaction by means of a bleaching agent, wherein the bleaching agent is stabilized by means of at least one stabilizer.

The invention relates to a method and an device for the pretreatment and dyeing of cellulose, according to the head of the independent claims.

In the paper ZHANG, S. Combinative scouring, bleaching, and cationization pretreatment of greige knitted cotton fabrics for facilely achieving salt-free reactive dyeing. Molecules 2017, 22, 2235, a pretreatment for salt-free dyeing of raw cotton is described. First, the washing and stabilized bleaching reagents are added and later the cationization reagent is added. If the cationizing reagent is added at the beginning of the bleaching reaction, this has the effect of reducing the degree of cationization of the cotton fibers.

It is the task of the present invention to create a Method and an device for the pretreatment and dyeing of cellulose which avoid the disadvantages of the prior art and, in particular, to create a method and an device for the pretreatment and dyeing of cellulose which achieve a dyeing method with an almost 100% degree of dye fixation within a very short time.

This task is solved by a method and an device for the pretreatment and dyeing of cellulose according to the independent claims.

According to the invention, the method for pretreating cellulose, comprises the following steps:
Providing a cellulose in the form of a textile fabric web, thread or fiber composite.
Providing treatment means comprising bleaching agent, at least one stabilizer and cationizing agent.
Carrying out a cationization reaction, in particular using the cationization agents to react with the cellulose.
Carrying out a bleaching reaction, in particular using hydrogen peroxide.

Whereby the bleaching agent is stabilized with the aid of at least one cationic or non-ionic stabilizer. The stabilizer preferably belongs to the group of organic or mineral-based stabilizers. In particular, alumina-based products; water glass, in particular sodium silicate; magnesium chloride, magnesium sulfate and phosphonates are preferred

The cellulose used in the claimed method is a natural raw material, such as cotton or linen. In addition, chemical fibers such as viscose fibers, modal fibers or cellulose acetate fibers are also produced from cellulose. Pretreatment is carried out, for example, on a linear textile structure made from cellulose, such as a yarn or twisted yarn. However, it can also be carried out on a fiber composite or thread composite in the form of a sheetlike textile structure, such as woven fabrics, knitted fabrics, braids, stitch-bonded fabrics, nonwovens or felts, or on a three-dimensional textile structure, such as a tube or a stocking.

By a cationization reaction is meant the reaction between hydroxyl groups of cellulose with a cationizing agent. The cationizing agent comprises a positively charged functional group which is still available after the reaction with the cellulose and reacts with a negatively charged dye molecule in a subsequent reaction.

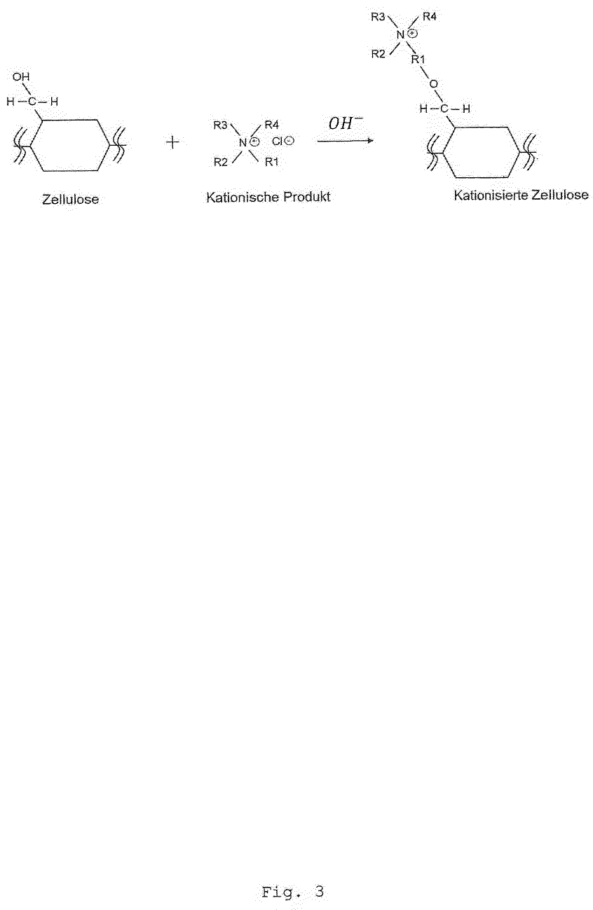

Quaternary ammonium salts with at least one positively charged group and at least one functional group for forming a bond with the cellulose are used as cationizing agents. Particularly preferred are cationizing agents comprising aliphatic radicals R1 to R4 on a nitrogen, wherein the aliphatic radical R1 comprises a hydroxyl group that forms a bond with the cellulose (FIG. 3).

Examples of possible cationizing agents are di-quaternary salts; quaternary polymers, such as 2-propen-1-aminium, N,N-dimethyl-N-2-propen-1-yl chloride, polymers with 1-chlorine-3-(2-propenamide)-2-propanol hydrochloride.

A bleaching reaction is understood to mean the removal and weakening of undesirable colorations in the cellulose. In this method, for example, undesirable basic colorations and vegetable impurities are removed. In addition, fat impurities are extracted and the absorbency becomes more uniform, resulting in improved and more even ink absorption. For the bleaching reaction, bleach is commonly used in the textile industry, which includes hydrogen peroxide, and provides the active oxygen needed for bleaching.

An addition of stabilizers allows the bleaching reaction to proceed slowly and in a controlled manner. Preferably, at least one cationic or non-ionic stabilizer is used for this purpose. Examples preferably come from the group of organic or mineral-based stabilizers, preferably alumina-based stabilizers, water glass, in particular sodium silicate, magnesium chloride, magnesium sulfate or phosphonates.

The advantage of the method described is that by using the specific stabilizers mentioned, no reaction takes place between the stabilizer and the cationizing agent used for the cationization.

Preferably, the bleaching reaction, the stabilization of the bleaching agent and the cationization reaction are carried out simultaneously. Simultaneously means that bleaching agent and cationizing agent are added at the same time.

This has the advantage that the pretreatment method is fast and cost-efficient.

Preferably, the performance of the bleaching reaction and the cationization reaction are carried out in the presence of an alkaline reacting substance. In particular, this can be done using caustic soda, caustic potash or sodium carbonate.

Alkaline-reacting substances have the advantage that they ensure a particularly suitable environment for the bleaching and cationization reaction.

Preferably, carrying out the cationization reaction leads to the formation of a covalent bond between the cationizing agent and the hydroxyl groups of the cellulose.

The formation of covalent bonds leads to advantageous, stable bonds between the hydroxyl groups of the cellulose and the cationizing agent.

Preferably, the method described is a continuous process.

Compared to the so-called exhaust processes, continuous processes have the advantage that they require much fewer resources, such as water, energy and chemicals.

Preferably, the continuous process is carried out according to an impregnation method, wherein the mass ratio of an applied treatment agent to the mass of the textile substrate is between 0.5 and 1.5, preferably <1.

By impregnation method, in this context, a PAD impregnation process is used, which is an impregnation method carried out according to the principle of forced application.

In this context, treatment agent means a mixture of bleaching agent, at least one stabilizer and cationizing agent. Typically, hydrogen peroxide is present in the bleach at a concentration of 0.1-1.6 mol/kg, while the stabilizer is present at a concentration of 2-16 g/kg and the cationizing agent with a cationic charge at a concentration of 0.1-1 mol/kg (cf. with “Cationic Cotton, Reservations to Reality”; M. J. Farrell, P. J. Hauser; AATCC Review September/October 2003).

It is particularly advantageous that the mass ratio of applied treatment agent to the mass of the textile substrate is between 0.5 and 1.5, preferably <1, since an optimum result of the treatment method is achieved with a minimum amount of treatment agent used.

Preferably, the process is carried out essentially at room temperature or at temperatures between 40° C. and 80° C., in particular between 60° C. and 70° C. Alternatively, the process is carried out under a saturated steam atmosphere at 100° C.

Carrying out the process at room temperature has the advantage of low energy consumption, which leads to lower process costs. Carrying out the process at temperatures between 40° C. and 80° C. or at 100° C. leads to optimized process conditions, accelerates the process reactions and thus shortens the overall process time.

Preferably, after carrying out the cationization reaction, a coloring treatment is carried out by dyeing or printing the cellulose. The coloring treatment is carried out by means of a treatment agent, in particular a coloring agent, which comprises an anionic water-soluble coloring agent or an insoluble pigment.

Reactive, acid, vat, disperse dyes or pigment dyes can be used as treatment agents.

Pretreatment is particularly advantageous because it leads to a dye fixation level of almost 100% in the dyeing methods mentioned.

Treatment agents are bleaching agents, stabilizers, cationization agents, dyeing agents.

The task is further solved by an device for the treatment of a textile substrate, a fabric web, a yarn or a fiber composite, which is carried out in particular by the method described above. The device comprises a feeding device for treatment agents, a reservoir for receiving the treatment agents and a circulation device.

Textile substrates are formed from yarns or nonwovens by different techniques such as weaving, knitting, tufting and fleece formation.

In this method, the treatment media are conveyed from the feed device to the reservoir, preferably via an incline or by means of pumps. The circulation device comprises one or more connections, preferably in the form of pipes and/or hoses, which in turn connect the reservoir to the feed device. The feeding device further comprises a controller that uses a level sensor to determine the fill level of the reservoir. If the fill level is below a predetermined level, the control increases the volumetric feed of the treatment agents. When the predetermined level is reached, the control system stops or reduces the supply of treatment agents. The circulation device also comprises a control system which regulates the discharge of the treatment agents via one or more lines of the circulation device back into the feed device. The return transport of the treatment means takes place with the help of the pumps.

The advantage of a circulation device is that, together with the feed device, the treatment agents can be distributed efficiently and evenly.

Preferably, the reservoir has at least one, preferably two outlets connected to the circulation device. Preferably, the circulation device additionally comprises an inlet for new treatment agents, so that fresh and recirculated treatment agents can be mixed with each other.

Fresh treatment agents enter the feed device via an inlet, while recirculated treatment agents are introduced into the feed device exclusively from the reservoir via the lines of the circulation device, with the aid of pumps.

The arrangement described has the advantage that fresh and recirculated treatment agents are so well mixed that optimum use of the treatment agents takes place.

The reservoir can be in the form of a gusset between two roll rollers and two sealing plates arranged at the roll ends. A drain is arranged on each side of the two sealing plates. The reservoir also includes a nitrogen sensor.

The advantage of this arrangement is that it requires very little handling equipment. The level sensor ensures that the reservoir with the treatment agents does not overflow.

The reservoir can be in the form of a dip tank.

The possibility of using a dip tank has the advantage that the device can also be integrated into an already existing conventional device.

Preferably, the feed device is designed in the form of a casting mechanism, an overflow weir or a slot die. Furthermore, the feeding device can be designed in an exchangeable form. The width of the feed device is 20 to 100% of the length of the roll rolls, preferably 40 to 100% of the roll roll and particularly preferably 80 to 100% of the length of the roll roll.

It is advantageous that the feeding device is exchangeable, so that the feeding device can be flexibly adapted to the given conditions. The fact that the width of a casting unit, an overflow weir or a slot die relative to the length of the roll rolls is 20 to 100%, preferably 40 to 100%, particularly preferably 80 to 100%, has the advantage that the textile substrate can be treated uniformly over its entire width, including the edge area.

Preferably, the longest dimension of the casting unit, slot die or overflow weir is between 50 to 5400 mm. Preferably it is between 1600 and 2400 mm.

The width of the textile substrate which runs parallel to the longest dimension of the casting unit, slot die or overflow weir is less wide than the casting unit, slot die or overflow weir. This has the advantage that the textile substrate is treated uniformly and simultaneously over the entire width.

Preferably, the device is made of a material that is resistant to the applicable reaction and cleaning agents. These can be caustic soda, water glass, organic wetting agents, sodium dithionite and other chemicals commonly used in textiles.

Resistant materials can be, for example, steel, stainless steel, glass-fiber reinforced plastics, natural or synthetic rubbers or wood. These materials have the advantage of being strong enough to keep wear to a minimum and to ensure a long service life.

Preferably, the circulation device is designed in such a way that a treatment agent can be fed to the reservoir uniformly and without interruption, at a rate of 25-35 l/min and meter width of the feed device or, in the case of viscosity-increased treatment agents, at a rate of 20 l/min and meter width of the feed device, across the width of the feed device.

For this purpose, pumps, in particular their power, and connections, in particular their length and diameter, of the circulation device are designed in such a way that treatment agents can be transported back into the feed device at a rate of 25-35 l/min and meter width of the feed device or, in the case of viscosity-increased treatment agents, at a rate of 20 l/min and meter width. Consequently, a pump preferably has a flow rate of 25 l/min and meter.

Whereby the viscosity-increased treatment agents comprise a dynamic viscosity in a range of 20-200 mPa*s at 20° C.

The width of the feeding device corresponds to the longest dimension of the feeding device and preferably corresponds to the width of the textile substrate.

Such an inflow of the treatment agent, leads to a uniform treatment of the textile substrate. In this case, fresh and recycled treatment agent are mixed so well that an optimized treatment of the materials to be treated takes place.

The task is further solved by a method for dyeing a textile substrate, which can be carried out using the previously described device. The method comprises the steps of:
Providing a textile substrate, in particular a substrate which has been pre-treated by means of a method as described above.
Providing a treatment agent, in particular a dyeing agent, preferably an anionic water-soluble dyeing agent or one or more insoluble pigments in a dispersing agent.
Carrying out a dyeing method by bringing the cellulose into contact with the treatment agent.

Reactive dyes, acid dyes, vat dyes, disperse dyes or pigment dyes can be used as treatment agents.

The advantage of the method described is that the textile substrate can be dyed to a uniform quality.

Preferably, the treatment agent is discharged via two outlets in the reservoir and fed into the feed device. Preferably, new treatment agent is introduced into the feed device via an inlet.

The described method has the advantage that fresh and recirculated treatment agents are mixed so well that an optimal use of the treatment agents takes place.

Preferably, passing the textile substrate into the reservoir comprises the following steps:
Introducing the textile substrate into a gusset-shaped reservoir filled with treatment agent.
Passing the textile substrate between two roller rolls.

The advantage of this method is the uniform dyeing.

The reservoir can be in the form of a dip tank.

The possibility of using a dip tank has the advantage that the device can also be integrated into an already existing conventional method.

Preferably, the treatment agent, in particular the dyeing agent, is added via a feed device in the form of a pouring unit, an overflow weir or a slot die. In this case, the treatment agent is added over a width of 20 to 100% of the length of the roll rollers, in particular 40 to 100% of the length of the roll rollers, preferably 80 to 100% of the length of the roll rollers, particularly preferably over the width of a textile substrate whose width is 200 mm shorter than the length of the roll rollers.

The addition of the treatment agent, in particular the dyeing agent, via a casting unit, an overflow weir or a slot die from 20 to 100% of the length of the roll rollers, in particular 40 to 100% of the length of the roll rollers, preferably 80 to 100% of the length of the roll rollers, particularly preferably over the width of a textile substrate, the width of which is 200 mm shorter than the length of the roll rollers, has the advantage that the textile substrate can be uniformly treated, in particular dyed, over its entire width including the edge region.

Preferably, the feeding device is in the form of a casting unit, an overflow weir or a slot die. Furthermore, the feeding device can be designed in an exchangeable form. The width of the feed device is 20 to 100% of the length of the roll rolls, preferably 40 to 100% of the roll roll and particularly preferably 80 to 100% of the length of the roll roll roll.

It is advantageous that the feeding device is exchangeable, so that the feeding device can be flexibly adapted to the given conditions. The fact that the width of a casting unit, an overflow weir or a slot die relative to the length of the roll rolls is 20 to 100%, preferably 40 to 100%, particularly preferably 80 to 100%, has the advantage that the textile substrate can be treated uniformly over its entire width, including the edge area.

Preferably, the treatment agent, in particular the dyeing agent, is added over the longest dimension of the casting unit, slot die or overflow weir between 50 and 5400 mm, preferably between 1600 and 2400 mm.

The addition of the treatment agent over this length has the advantage that the textile substrate is treated uniformly and simultaneously over the entire width.

Preferably, the treatment agent is fed uniformly and without interruption, at a rate of 25-35 l/min and meter of the width of the feed device or, in the case of viscosity-increased treatment agents, at a rate of 20 l/min and meter of the width of the feed device, across the width of the feed device to the reservoir.

Such an inflow of the treatment agent, results in a uniform treatment of the textile substrate.

The invention is further explained below with reference to examples of embodiments shown in figures. Hereby show:

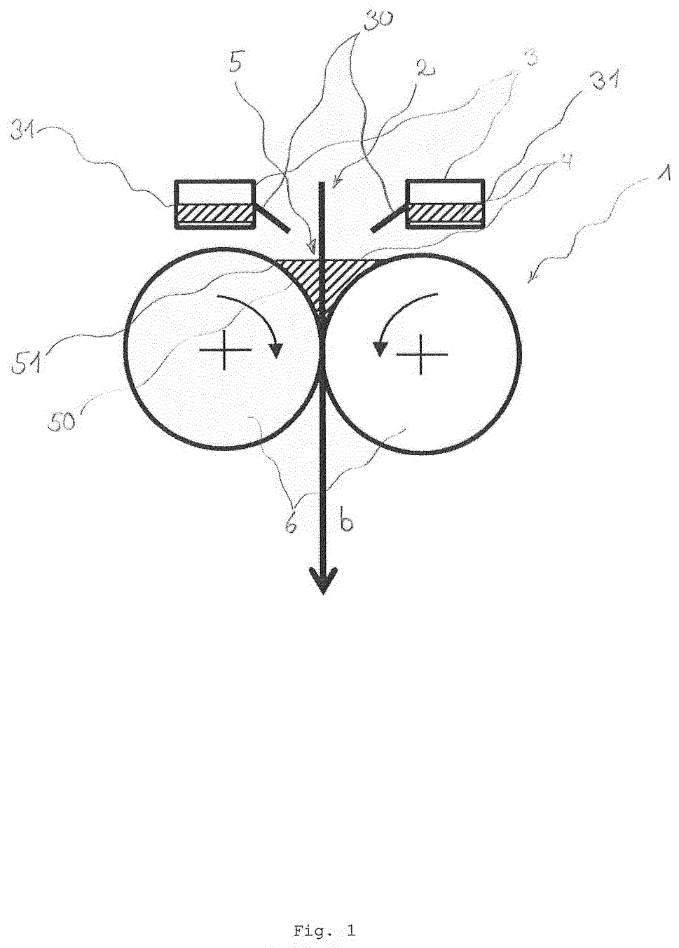

FIG. 1: Side view of a device in a first embodiment

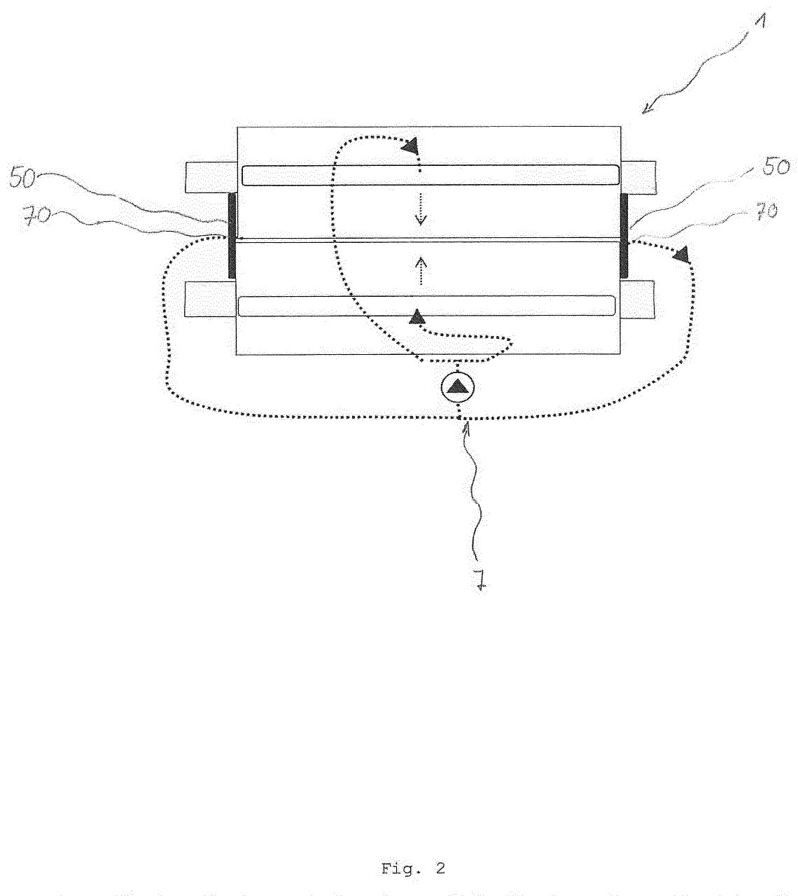

FIG. 2: Top view of a device in a first embodiment

An device 1 shown in FIG. 1 is used for the treatment of a cellulose-containing textile fabric web 2, which is moved in a continuous process at room temperature in a direction of movement b. The device 1 comprises a casting unit, a caster, and a calender.

The device 1 comprises a casting unit 3 for feeding 30 treatment agent 4, which is in an anionic dyeing agent, a gusset 5, which forms a reservoir 5 by means of lateral sealing plates 50 and a pair of squeeze rollers 6. In addition, FIG. 1 shows a level sensor 51 which prevents the treatment agent 4 from overflowing from the gusset 5.

The caster 3 feeds the treatment agent 4 uniformly and without interruption along the cellulose-containing textile fabric web 2 into the gusset 5 via the feed 30 over its entire width of 2400 mm. 0.5 to 1.5 kg of treatment agent 4 is added to 1 kg of cellulose-containing textile fabric web 2.

The cellulose-containing textile fabric web 2 is passed through the gusset 5 and the nip roller pair 6. With the aid of the treatment means 4, the cellulose-containing textile fabric web 2 is dyed.

FIG. 2 shows the device 1 for treating the cellulose-containing textile fabric web 2 and its circulation device 7 in plan view. The circulation device 7 comprises an outlet 70 at each of the two lateral sealing plates 50 arranged at the gusset 5 and an inlet 31 at the casting unit 3. With the aid of the two outlets 70, the treatment agent 4 can be fed from the gusset 5 back into the casting unit 3. Via the inlet 31, fresh treatment agent 4 is fed to the casting unit 3, which mixes with the recycled treatment agent 4 from the gusset 5 and is used again to treat the cellulose-containing textile fabric web 2.

1. A method of pretreating cellulose, comprising the steps of:
Providing a cellulose in the form of a textile web, thread or fiber composite;
providing treatment means comprising bleaching agents, a stabilizer and cationizing agents;
carrying out a cationization reaction;
carrying out a bleaching reaction by means of bleaching agents,
the bleaching agent being stabilized with the aid of at least one cationic or a non-ionic stabilizer.

2. The method according to claim 1, wherein the bleaching reaction, the stabilization of the bleaching agent and the cationization reaction are carried out essentially simultaneously.

3. The method according to claim 1, wherein the bleaching reaction and the cationization reaction are carried out in the presence of an alkaline reacting substance.

4. The method according to claim 1, wherein carrying out the cationization reaction leads to the formation of a covalent bond between cationization agent and the hydroxyl groups of the cellulose.

5. The method according to claim 1, wherein it is a continuous process.

6. The method according to claim 5, wherein the continuous process is carried out according to an impregnation method, wherein the mass ratio of the applied treatment agent to the mass of the textile is between 0.5 and 1.5.

7. The method according to claim 1, wherein the method is carried out essentially at room temperature or at temperatures between 40° C. and 80° C.

8. The method according to claim 1, wherein after the cationization reaction has been carried out, a coloring treatment is carried out by dyeing or printing the cellulose by means of a treatment agent, the treatment agent being an anionic water-soluble dye or an insoluble pigment.

9. A device for treating a textile substrate in the form of a fabric web, a thread or fiber composite, comprising a feed device of treatment means, a reservoir for receiving the treatment means, wherein the device further comprises a circulation device for circulation of the treatment means.

10. The device according to claim 9, wherein the reservoir has at least one outlets which is connected to the circulation device and the circulation device additionally comprises an inlet for new treatment agents, so that fresh and recirculated treatment agents can be mixed.

11. The device according to claim 9, wherein the reservoir is designed in the form of a gusset between two roller rolls and two sealing plates arranged at the ends of the rollers, and an outlet is arranged on each side of the two sealing plates, and the reservoir comprises a level sensor.

12. The device according to claim 9, wherein the reservoir is designed in the form of a submersible basin.

13. The device according to claim 9, wherein the feed device is designed in the form of a casting mechanism, an overflow weir or a slotted nozzle and in interchangeable form, the width of which is 20 to 100% of the length of one of the roller rolls.

14. The device according to claim 13, wherein the longest dimension of the casting unit, the slot die or the overflow weir is between 50 and 5400 mm.

15. The device according to claim 9, wherein the circulation device is designed in such a way that a treatment agent can be fed uniformly and without interruption, at a rate of 25-35 l/min and meter of the width of the feed device or, in the case of viscosity-increased treatment agents, at a rate of 20 l/min and meter of the width of the feed device, over the width of the feed device to the reservoir.

16. A method of dyeing a textile substrate, in particular using an device according to claim 9, comprising the steps of:
Providing a textile substrate, in particular a substrate which has been pretreated by means of a method as described above;
providing a treatment agent,
carrying out a dyeing method by bringing the cellulose into contact with the dyeing agent.
